(19) United States
(12) Patent Application Publication
(10) Pub. No.: US 2022/0349744 A1
(43) Pub. Date: Nov. 3, 2022

(54) Device and Method for Measuring and Visualization of Sound Level

(71) Applicant: SANSOGLYS AS, Hagan (NO)

(72) Inventors: Anette Tveten, Hagan (NO); Gro Ingvild Røvang, Nittedal (NO); Niels Bjørn Olsen, Hagan (NO)

(21) Appl. No.: 17/621,261

(22) PCT Filed: Jun. 19, 2020
(86) PCT No.: PCT/NO2020/050169

§ 371 Date: Dec. 21, 2021

(30) Foreign Application Priority Data
Jun. 21, 2019 (NO) 20190768

(51) Int. Cl. G01H 3/14; G01D 7/00

(52) U.S. Cl. CPC G01H 3/14; G01D 7/002; H04R 29/008

(57) ABSTRACT

Device and method for measuring and visualizing the sound level in a place where at least two people are gathered, comprising at least one sound detector which is connected to at least one visualization device in such a way that the visualization device responds to sound at the place. The visualization device is arranged so that it provides a gradually increasing response to gradually decreasing sound level. The visualization can be instantaneous or show average values for a defined period of time. The device is typically reversible so that it also provides a decreasing response to increasing noise levels. Instructions are given for use in gathering locations such as school classes, kindergarten rooms, meeting rooms, party rooms and group rooms for people with special behavioural challenges.

### BACKGROUND

The present disclosure relates to a device for measuring and visualizing of sound level and an associated a method for measuring and visualizing sound level.

Noise is an important public health problem. It has negative consequences for human health and well-being and is a growing concern. Authorities and organizations have developed guidelines, based on a growing understanding of the health effects caused by exposure to noise. One example is a report from the World Health Organization (WHO) on guidelines for exposing people to noise (http://www.euro.who.int/_data/assets/pdf_file/0008/383921/noise-guidelines-eng.pdf?ua=1). The main purpose of these guidelines is to provide recommendations to protect human health from exposure to environmental noise from various sources: noise from transport (road traffic, railways and aircraft), noise from wind turbines and leisure noise. The health advice is supported by facts, which is crucial for producing measures that can protect local communities from the unwanted effects of noise. Exposure levels are recommended that can be considered applicable in several geographic areas.

In addition to noise from the outdoor environment, noise from the indoor environment can pose health challenges. Noise in the workplace is usually regulated and can be limited by per se known technical devices on noise sources or protective equipment. Noise can be measured and visualized so that a person who is exposed to the noise can be notified. The same applies to noise from other indoor environments.

DE 202007007942 U1 is a German utility model that describes a noise level detector that is connected to one or more LEDs (light emitting diode). The LED(s) light up when the noise level exceeds a predetermined value. CN 206609519 U is a Chinese utility pattern with a device comparable to DE 202007007942 U1. It states that the facility has a “reasonable” design and includes some data analysis of measured noise values.

KR 20180093503 A discusses an acoustic meter that visualizes indoor noise using light. An embodiment with a LED line as light is mentioned. The use of the product as a warning system from patient to nurse is discussed. CN 106595844 A discloses a wireless network-based noise monitoring system in industrial areas using LEDs to visualize the noise level. Low cost manufacturing of the noise monitoring system and its use in institutions and schools is discussed. CN 205642605 U discusses a multifunctional noise meter with improved precision that shows the measured noise level on an LED LCD screen (liquid crystal display). U.S. Pat. No. 7,836,770 BB discloses a personal noise dose meter. Accumulated noise is calculated and displayed, for example, by a LED line. KR 20050049774 A discusses a measuring system for rattling sound in cars. Display of the sound level with LED is mentioned.

U.S. Pat. No. 6,098,463 A describes a device for measuring physical signals, including sound. The device measures the sound level and can display it visually with light signals.

U.S. Pat. No. 3,797,012 A discloses a device for measuring and visualizing sound level comprising at least one microphone for detecting sound level, wherein this is connected to a visualization device which responds at sound level. The visualization device can change from smiley face to sourpass and vice versa.

Measurement of noise in different ways and visualization with LED are discussed in all the above-mentioned publications. As a rule, the persons involved are notified when an acute or accumulated noise level exceeds a predetermined limit value. Generation of signals/feedback to involved persons that motivates them to implement measures to reduce the noise level is not mentioned in any of the publications. Noise in the indoor environment caused by people can be difficult to reduce with technical aids. In addition, the use of protective equipment may be impractical.

### SUMMARY

Disclosed embodiments provide an alternative to known devices for measuring and visualizing sound level.

More specifically, provided herein is a device for measuring and visualizing sound level as a pedagogical aid for reducing man-made sound/noise.

More specifically, provided herein is a device, which motivates the persons involved to reduce the sound level individually and jointly.

Health problems that can be linked to exposure of people to noise are a major societal challenge. Reducing the exposure of people to high sound levels/noise leads to increased quality of life for the people involved and reduced costs for society.

The disclosed embodiments apply to measuring and visualizing the sound level in a place where at least two people are gathered. The device for measuring and visualizing the sound level comprises a sound detector which is connected to a visualization device in such a way that the visualization device responds to sound on site. The sound detector must include at least one microphone and sufficient electronics to provide an output signal that depends on the sound level that the microphone picks up.

The visualization device is arranged so that it gives a gradually increasing response to gradually decreasing sound level. The gradually increasing response to decreasing sound level can inspire and motivate the gathered persons to reduce the sound level until the goal in the form of a predetermined acceptable sound level is reached.

The visualization device may be an analog display or a lighting device. The person skilled in the art may find several suitable visualization devices for carrying out the embodiments. A visualization device that is a lighting device can change from warmer to colder colours and vice versa.

The gradually increasing response to gradually decreasing sound level may consist of increasing (stronger) light and shifting from colder to warmer colours. In the opposite case, the gradually decreasing response to gradually increasing sound level may consist of decreasing (weaker) light and shifting from warmer to colder colours.

Preferably, the device comprises a control device which, among other things, is capable of recording average values of sound level over a certain period of time, for example a period of up to 3 seconds, up to 15 seconds or up to 1 minute.

The device is preferably reversible, i.e. it gives a gradually decreasing response to a gradually increasing sound level. In the extreme, the gradually decreasing response to a gradually increasing sound level can lead to virtually absent light, when the sound level has exceeded a predetermined threshold for a continuous period of time.

The control device may be arranged to receive information about various parameters that are assumed to affect the sound level, such as the level of background noise that cannot be influenced, the number of people present, whether there is a meeting, party or other type of gathering, etc.

The gradually increasing response to gradually decreasing sound level can thus be “calibrated” according to various parameters that have a direct influence on the sound level. In addition, health-related data from authorities and professional communities for sound exposure of persons can form the basis for control and the course of the increasing response to gradually decreasing sound levels and vice versa.

Programming and/or calibration of the control device can take place in various ways, for example with a so-called app where the number of people gathered in the room, type of gathering, form of gathering and health-related data from authorities and professional communities for sound exposure of people are entered into the app and the course of the gradually increasing response to gradually decreasing sound level is fed out of the app and into the device.

The control device may optionally be equipped with a memory unit which allows the device to store history of what is recorded, for example for a certain number of persons present in a certain room, in a certain type of gathering and in a certain form of gathering, the history forms the basis for statistics fed out of the app.

When the device is arranged to be programmed by an app, it is also expedient that the response obtained can be read in the mobile device containing the app. This presupposes two-way communication between the mobile unit and the device.

The visualization device of the device can be made in different sizes, which are adapted to rooms with different sizes and gatherings of different type and scope.

The device can be used in connection with meetings and gatherings where people with neurological disorders such as ADHD are present. The inventive embodiments make it possible to include such persons in the community who together will achieve a reduced sound level.

The device can also be used in places where several people are gathered who basically do not know each other and usually do not feel community for each other. Examples could be a museum, library, quiet compartment on the train, church building, and other similar areas in the community. It can be embarrassing to be reminded to observe silence or lower the volume. The device can in a more positive way contribute to increased support for the desired silence/the reduced sound level, so that the goal is achieved with a smile. Locations that have installed the device may in their marketing indicate that the device exists and that the sound level has been reduced.

Furthermore, the disclosed embodiments relate to a method for measuring and visualizing the sound level in a place where at least two people are gathered using a sound detector which is connected to a visualization device in such a way that the visualization device responds to sound on the spot and that the visualization device provides a gradually increasing response to gradually decreasing sound level. The method may also comprise that the gradually increasing response to gradually decreasing sound level in the visualization device leads to the undershot of a predetermined sound level, as persons present in the room attenuate their sound-creating activities, as a result of the gradually increasing response in the visualizing device.

### BRIEF DESCRIPTION OF THE DRAWINGS

In the following, the invention is explained in more detail through some non-limiting embodiments illustrated in the accompanying figures, in which:

FIG. 1A schematically shows an arrangement of a first embodiment.

FIG. 1B schematically shows an arrangement of a second embodiment.

FIG. 1C schematically shows an arrangement of a third embodiment.

FIG. 1 D schematically shows an arrangement of a fourth embodiment.

FIG. 2A schematically shows a graph of the first relationship between volume and visualization.

FIG. 2B schematically shows a graph of another relationship between volume and visualization.

FIGS. 3A-3F schematically show in several steps a specific type of visualization.

FIGS. 4A-4C schematically show in three steps an alternative visualization to that shown in FIGS. 3A-3F.

### DETAILED DESCRIPTION

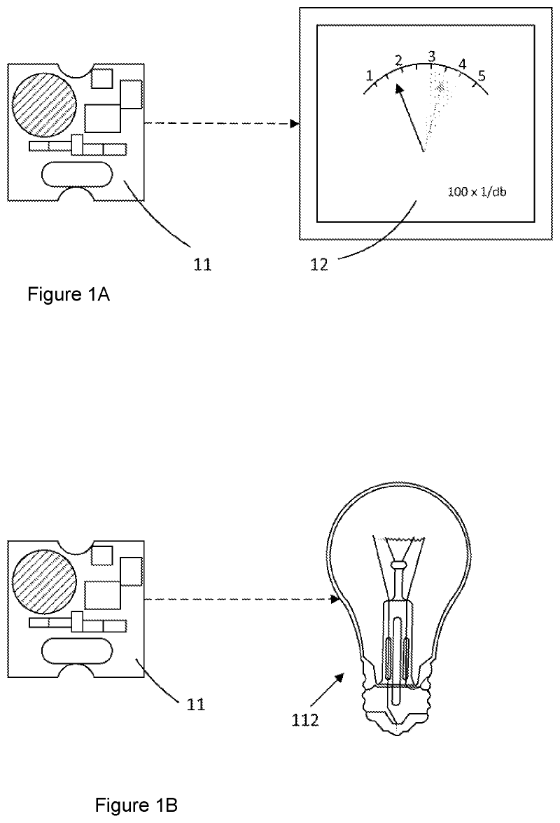

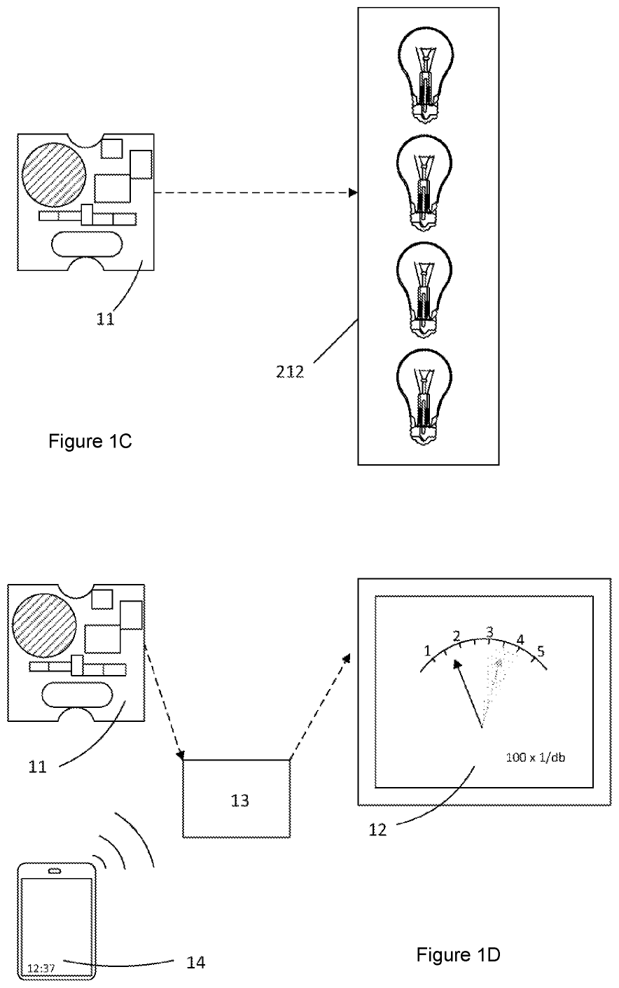

FIG. 1A shows a sound detector 11 which is connected to a visualization device 12 shown as an analogue meter. The reading on the meter can, for example, be proportional to 1/db. The desired area can be shaded as shown in the figure. Note that it is not necessarily the case that the lowest possible sound is the most desirable situation; where people meet, it is natural and usually desirable that the sound is kept within an area where some sound is present, not too loud, but also not completely quiet. In its simplest form, there is no control and no memory included, only an immediate display of the existing sound level at any given time. The detector 11 contains a microphone and sufficient electronics to provide an output signal, which is inverted in relation to the measured sound level.

FIG. 1B shows in principle the same as FIG. 1A, but with a visualization device in the form of a lamp 112. It is understood that the lamp is equipped with the necessary power supply, either from the mains or from the battery. The current of the lamp is controlled from the detector 11 in such a way that a weak sound level produces stronger (more) light than a high sound level.

FIG. 1C shows a variant of FIG. 1B, where more than 1 lamp is included. This may be appropriate if the area being measured is large and not everyone present is able to see a single lamp. However, one can also use a system of lamps connected so that more and more lamps are lit as the sound level decreases, and vice versa, instead of—or in addition to—the brightness of the individual lamp being adjusted step by step. Optionally, the colors may also be different in the different lamps as discussed in more detail below.

FIG. 1D shows a layout which basically corresponds to the layout in FIG. 1A, but which includes a control device 13 which is programmable, which means that the device can be changed as required, for example depending on the number of people present, what type of gathering is going on, for example party or meeting or lunch room, etc. The control device 13 can also contain a memory that enables storage of and comparison with historical data, reporting of development, etc. Finally, the control device can be arranged so that it is wirelessly programmable from a smart mobile phone 14 by means of a so-called app.

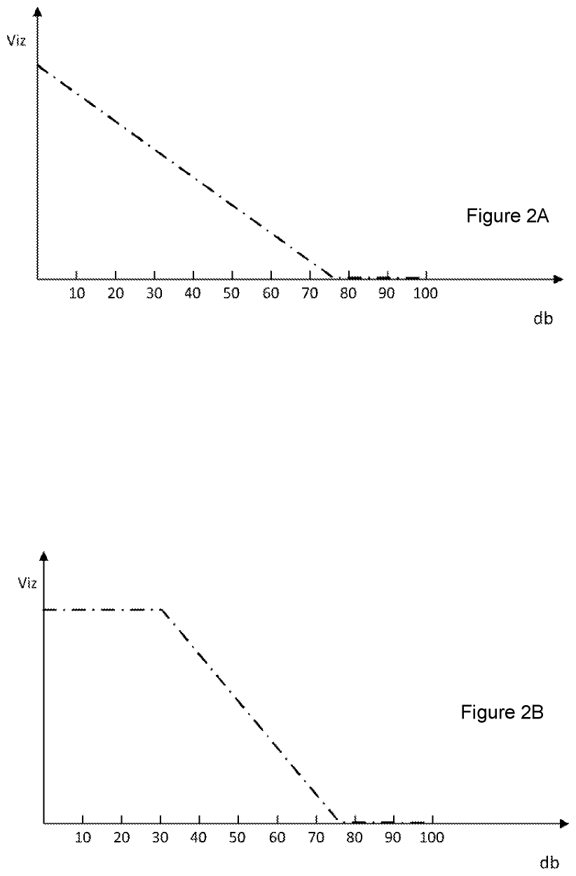

FIG. 2A shows a relationship between a visualized response (Viz) and a measured sound level. The response decreases with increasing volume from 0 db to a zero response at 75 db. When used in combination with a control device 13 as shown in FIG. 1D, e.g. the sound level at which the response becomes zero is reprogrammed as desired. In the opposite direction, the visualized response increases with decreasing sound level. The figure also illustrates the fact that with increasing sound level, a level will be reached after which no further change occurs. This means that in the event of a gradually decreasing response at a gradually increasing sound level, the device will show an absence of response when the sound level has exceeded a predetermined threshold, possibly for a continuous period of time.

FIG. 2B shows an alternative course where the maximum response is reached when the sound level drops to 30 db. Often there will be background noise at this level, or higher, and it would be unmotivating if you were not able to achieve maximum response due to conditions you are not able to influence. Again, it will be the case that if the device comprises a programmable control device, it can also be possible to adjust the level where the maximum response is achieved as desired.

In both FIGS. 2A and 2B, the area where the visualization changes is shown as a straight, sloping line. However, it is not a prerequisite that the visualization is linearly dependent on the (inversed) sound level. Moreover, the db scale in which sound volume is typically measured, has in itself an exponential scale, and a linear response to an exponentially produced base value (as sound volume) is not a linear response to the base value itself.

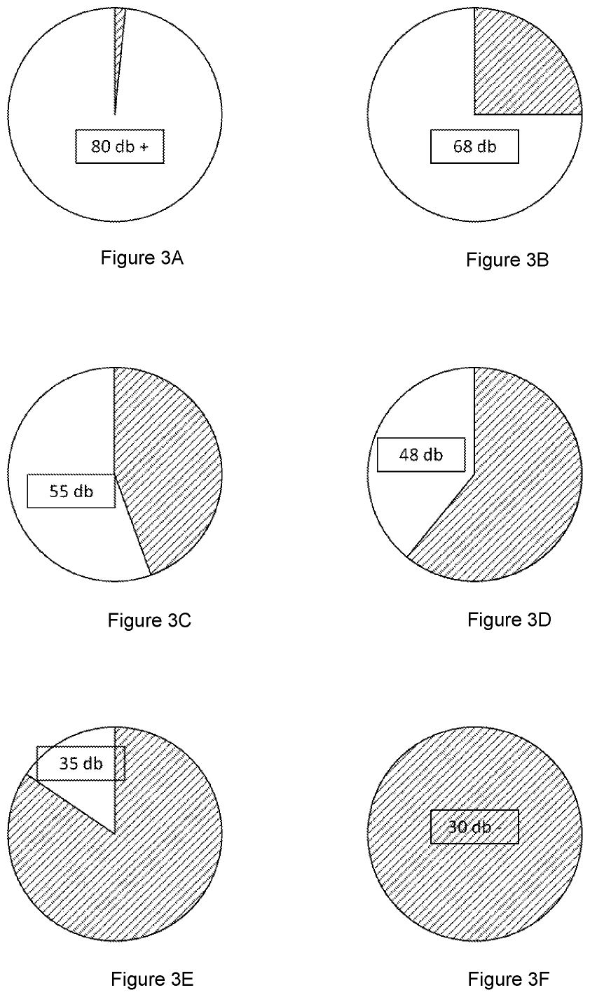

FIGS. 3A-3F show an alternative form of visualization of the measured sound by means of a digital drawing program, where the sound as shown in FIG. 3A is represented as a minimal circle segment when the sound exceeds a maximum level, for example 80 db, while increasingly of the circle is drawn out the more the sound is reduced down to a desired minimum level, which in FIG. 3F is shown as 30 db. It should be emphasized that the figures are only exemplary and that in various alternative situations a sound level of 35 db, 40 db, 45 db or 50 db can be regarded as within the optimal range. The visualization according to FIGS. 3A-3F can take place on a computer screen or the like by means of a digital drawing program known per se.

As mentioned, an increasing response can also be shown with colors, and more specifically that increasing response is to be understood as a shift from cold to warm colors, i.e. a shift from shortwave (blue) light in the direction of long-wave (red) light. Blue light has wavelengths in the range 445 to 520 nm, while red light has wavelengths in the range 625 to 740 nm.

The use of color can also be combined with such a drawing of a circle as shown in FIGS. 3A-3F, for example starting with blue color of the circle segment in the first quadrant (<90 degrees), transition to green into the second quadrant (>90 degrees), further transition to yellow into the third quadrant (>180 degrees), transition to orange into the fourth quadrant (>270 degrees) and change to red when the circle is fully drawn (360 degrees).

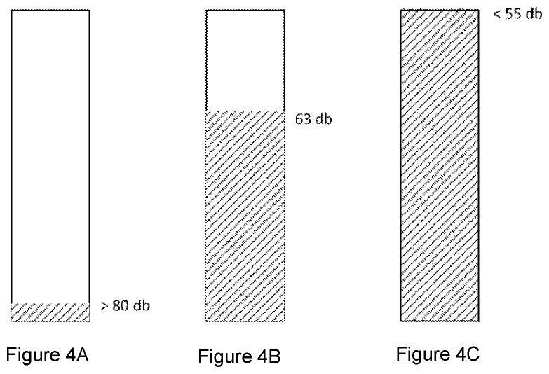

The FIGS. 4A-4C show an alternative visualization to that shown in FIGS. 3A-3F where the sound level is presented as a bar graph. A visible but minimal bar is drawn at 80 db and sound levels above this level. The height of the bar is gradually increased with decreasing sound down to 55 db and remains a fully subscribed bar at all sound levels below this level. The figure illustrates in addition to the form of the visualization that a sound level lower than 55 dB is not always of interest to strive for, either based on background noise or the type of gathering at which the measurement is made.

It is emphasized that the disclosed embodiments do not bring anything new with regard to lighting devices, analog displays, drawing programs, etc. It is assumed to use per se known technology when it comes to implementing such devices for the relevant displays of noise level.

The visualization devices can be used in different shapes and sizes that are adapted to different areas of use.

The disclosed embodiments can be used in many different contexts and places, such as in assemblies such as school classes, kindergarten departments, meeting rooms, party rooms and group rooms for people with special behavioural challenges.

1-15. (canceled)

16. A device for measuring and visualizing sound level in a location wherein at least two persons are present, comprising
at least one sound detector connected to at least one visualization device such that the visualization device responds to sound on the spot, wherein
the visualization device is configured to provide a gradually increasing response to gradually decreasing sound level.

17. The device according to claim 16, further comprising a control device that allows the visualization device to provide a response based on registered average values of sound level within a defined period of time.

18. The device according to claim 16, wherein the visualization device is an analogue display.

19. The device according to claim 16, wherein the visualization device comprises a digital drawing program configured for generating graphic shapes.

20. The device according to claim 17, wherein the visualization device comprises a digital drawing program configured for generating graphic shapes.

21. The device according to claim 16, wherein the visualization device is a lighting device.

22. The device according to claim 17, wherein the visualization device is a lighting device.

23. The device according to claim 21, wherein the lighting device is configured to provide stronger light in response to decreasing sound level.

24. The device according to claim 21, wherein the lighting device is arranged to change from cold colors to warm colors in response to decreasing sound level.

25. The device according to claim 17, wherein the gradually increasing response to gradually decreasing sound level is based on one or more parameters selected from the group consisting of the number of persons gathered in the room, type of gathering, form of gathering and health-related data from authorities and professional communities for sound exposure of persons.

26. The device according to claim 17, wherein the device is configured to be controlled by an app wherein the number of people gathered in the room, type of gathering, form of gathering and health-related data from authorities and professional communities for sound exposure of people are entered in the app and the course of the gradually increasing response to gradually decreasing sound level is fed from the app into the device.

27. The device according to claim 17, wherein the device is configured to store history for any setup, and wherein the history forms the basis for statistics and comparison between recent and historical data.

28. The device according to claim 21, wherein the device is configured to store history for any setup, and wherein the history forms the basis for statistics and comparison between recent and historical data.

29. The device according to claim 23, wherein the device is configured to store history for any setup, and wherein the history forms the basis for statistics and comparison between recent and historical data.

30. The device according to claim 16, characterized in that the visualization device is available in different shapes and sizes which are adapted to different areas of use.

31. The device according to claim 16, wherein the device is additionally configured to provide a gradually decreasing response to gradually increasing sound level.

32. The device according to claim 31, wherein the gradually decreasing response at gradually increasing sound level is configured to exhibit absence of response when the sound level has exceeded a predetermined threshold for a continuous period of time.

33. The device according to claim 17, wherein the gradually decreasing response at gradually increasing sound level is configured to exhibit absence of response when the sound level has exceeded a predetermined threshold for a continuous period of time.

34. A method for measuring and visualizing sound level in a location wherein at least two people are present, comprising
providing at least one sound detector,
connecting the sound detector to at least one visualizing device such that the visualizing device responds to sound on the spot,
connecting the visualizing device to the sound detector such that the visualizing device provides a gradually increasing response to gradually decreasing sound level.

35. A use of the device according to claim 16 for visualizing sound in assemblies selected from the group consisting of school classes, kindergarten departments, meeting rooms, party rooms and group rooms for individuals with behavioural challenges.
